(19) United States
(12) Patent Application Publication
(10) Pub. No.: US 2021/0114202 A1
(43) Pub. Date: Apr. 22, 2021

(54) ROBOT USING THE PARALLELOGRAM PRINCIPLE

(71) Applicant: Suzhou Shenyun robot Co., Ltd., Suzhou City, Jiangsu (CN)

(72) Inventors: Pangen Lu, Suzhou City, Jiangsu (CN); Wenlong Ge, Suzhou City, Jiangsu (CN); Guoping Hu, Suzhou City, Jiangsu (CN)

(21) Appl. No.: 15/122,811

(22) PCT Filed: Mar. 7, 2016
(86) PCT No.: PCT/CN2016/075793

§ 371 Date: Dec. 3, 2020

(30) Foreign Application Priority Data
Apr. 2, 2015 (CN) 201510155279.5

(51) Int. Cl. B25J 9/10; B25J 9/04; B25J 18/04; B25J 19/00

(52) U.S. Cl. CPC B25J 9/1065; B25J 19/0091; B25J 18/04; B25J 9/04

(57) ABSTRACT

A robot using the parallelogram principle, wherein the heads and the ends of two groups of swing arm components are hinged together, and each group forms two parallelogram hinged structures; wherein the workpiece gripped by the gripper can be kept in a horizontal position during the operational process, thereby improving the stability of gripping a workpiece. Additionally, the robot using the parallelogram principle comprises a base having a main shaft, which can rotate horizontally; one end of the main shaft comprises a main shaft servo motor for propelling the main shaft to rotate and the other end of the main shaft is connected to the swing arm components; wherein the main shaft servo motor further propels the swing arm components to swing in circumferential direction around the main shaft by propelling the main shaft.

### TECHNICAL FIELD OF THE INVENTION

The present invention relates to the technical field of industrial robots, and more particularly, to a robot using the parallelogram principle.

### BACKGROUND OF THE INVENTION

Robotic automation production lines are widely used in today's industries. Specifically, industrial robot automatic production lines have been widely used in the automotive, electronic, engineering, and other industries for ensuring product quality, improving production efficiency and avoiding a significant number of industrial accidents.

The traditional single-armed swing manipulator moves in a circular-arc path. Consequently, the suction cup of the mechanical gripper is difficult to move straight in a horizontal direction. In order to maintain the horizontal movement of the gripper's suction cup, an auxiliary power mechanism is usually required, resulting in an increased manufacturing cost. In the prior art, the single transmission arm of the manipulator has the disadvantage of low stability, and the manipulator is prone to shake during the movement. This greatly diminishes the control accuracy of the manipulator and fails to meet the necessary standards of precision.

### SUMMARY OF THE INVENTION

The purpose of the present invention is to overcome the shortcomings in the prior art and provide a robot using the parallelogram principle of which the heads and the ends of two groups of swing arm components are hinged together and each group forms two hinged parallelogram structures. Consequently, the workpiece gripped by the gripper can be kept in a horizontal position during the operational process, thereby improving stability when gripping a workpiece.

To achieve the above purpose, the present invention adopts the following technical solution:

A robot using the parallelogram principle comprises a base, wherein the main shaft can rotate horizontally. One end of the main shaft comprises a main shaft servo motor for propelling the main shaft to rotate, and the other end of the main shaft is connected to the swing arm components. The main shaft servo motor further propels the swing arm components to swing in a circumferential direction around the main shaft by propelling the main shaft. The free end of the swing arm components is connected to a gripper for gripping a workpiece. The swing arm components comprise the first swing arm components and the second swing arm components, which are hinged together. The first swing arm components comprise the first arm, which is hinged to the end of the main shaft. One side of the first arm is provided with two first control rods for supporting the swing of the first arm. The two first control rods and the first arm form a hinged parallelogram structure. The two first control rods also form a hinged parallelogram structure. The second swing arm components comprise the second arm and two second control rods. One end of the second arm is hinged to one end of the first arm, which is far from the main shaft. The other end of the second arm is hinged to the gripper. The two second control rods are respectively hinged to the ends of the two first control rods, and the two second control rods form a hinged parallelogram structure. The two second control rods and the second arm also form a hinged parallelogram structure. The first arm working module, which is used for propelling the first arm to rotate nearer or farther from the processing position of a workpiece, is disposed between the first arm and the main shaft. The second arm working module, which is used for propelling the second arm to rotate nearer or farther from the processing position of a workpiece, is disposed between the second arm and the first arm. One end of the second arm, which is far from the first arm, is hinged to the third arm rotating sleeve. The third arm rotating sleeve comprises the rotatable third arm. One end of the third arm, which extends towards one side of the second control rod in a horizontal direction, is connected to a parallel fixed plate. The parallel fixed plate is hinged to the end of the second control rod. One end of the third arm, which is far from the second control rod, extends through the third arm rotating sleeve and is fixedly connected to the gripper.

In another embodiment of the present invention, the gripper comprises a transverse-direction driving unit, a vertical-direction driving unit and an end gripper. The transverse-direction driving unit comprises a horizontal transverse support and a horizontal transverse power unit. The vertical-direction driving unit comprises a vertical-direction power unit and a vertical-direction support; the third arm extends through the third arm rotating sleeve and fixedly connects to the horizontal transverse support; the interior of the horizontal transverse support is provided with a horizontal transverse track. The vertical-direction support is movably coupled in the horizontal transverse track. The output end of the horizontal transverse power unit is connected to the vertical-direction support. The vertical-direction support reciprocates along the horizontal transverse track. The vertical-direction track is provided inside the vertical-direction support; a vertical-direction sliding block is embedded in the vertical-direction track; the vertical-direction sliding block is connected to the end gripper through the connecting rod; the output end of the vertical-direction power unit is connected to the vertical-direction sliding block.

Additionally, the length of the horizontal transverse track is 1500 mm.

In some embodiments, the horizontal transverse power unit comprises a flexible shaft servo motor, a motor output flexible shaft, a driving synchronous wheel, a driven synchronous wheel and a synchronous belt; the flexible shaft servo motor is connected to the driving synchronous wheel through the motor output flexible shaft. The driving synchronous wheel is connected to the driven synchronous wheel through the synchronous belt; the synchronous belt is disposed in the transverse-direction installation channel of the horizontal transverse support. The driving synchronous wheel and the driven synchronous wheel are respectively disposed at the two ends of the transverse-direction installation channel. The end face of the outer side of the synchronous belt is fixedly connected to the vertical-direction support. Meanwhile, the vertical-direction support is movably coupled in the protruding horizontal transverse track. The flexible shaft servo motor propels the driving synchronous wheel to rotate so that the synchronous belt is propelled to drive the vertical-direction support to horizontally move along the horizontal transverse track. Consequently, the end gripper can move horizontally, providing a wider working range to the robot.

In another embodiment, a transverse-direction balance block is disposed in the horizontal transverse support so as to ensure the stability of the whole structure during the operation.

The transverse-direction balance block is embedded in the internal chamber of the horizontal transverse support and fixed to the horizontal transverse track through the balance block connecting plate so that the horizontal transverse track can be arranged reasonably and the structure has more stability.

In some embodiments, the flexible shaft servo motor is fixed to the second arm; the length of the motor output flexible shaft can ensure the normal operation of the robot and avoid tangles.

Specifically, the vertical-direction power unit is a vertical-direction cylinder; the vertical-direction cylinder is fixed to the vertical-direction support. The lower end of the piston rod of the vertical-direction cylinder is connected to the vertical-direction sliding block; the vertical-direction sliding block is propelled by the vertical-direction cylinder to move upwards and downwards along the vertical-direction track, enabling the end gripper to be adjusted precisely in the vertical direction.

A gravity balance block is disposed under the main shaft, which is disposed far from the first arm. When the main shaft is not rotating, the gravity center of the gravity balance block and the plane of the axis line of the main shaft are perpendicular to the horizontal plane, reducing the driving power accordingly and resulting in decrease of power consumption.

In some embodiments, the end of the main shaft, which is far from the first arm, comprises a damping brake mechanism, which can produce varying damping force according to the size of the rotational angle so as to reduce the motion inertia of the main shaft.

In some embodiments, the first arm working module comprises the first arm working pushrod. One end of the first arm working pushrod is hinged to the first arm and the other end is hinged to the first sliding block; the first sliding block is disposed in the guide track of the first arm working module. The first sliding block is propelled by the first arm working module servo motor to reciprocate linearly along the axis direction of the main shaft.

The first sliding block is connected to the end of the first arm working module through the damping spring group, reducing the gravity and motion inertia when the first arm moves to −45°˜−80. Consequently, the driving power of the first arm working module and the power consumption during the operation can be reduced accordingly.

The second arm working module comprises the second arm working pushrod. One end of the second arm working pushrod is hinged to the second arm and the other end is hinged to the second sliding block. The second sliding block is disposed in the guide track of the second arm working module. The second sliding block is propelled by the second arm working module servo motor to reciprocate linearly along the axis direction of the second arm.

The upper part of the inner side of the first arm is provided with a damping spring plate. The damping spring plate starts to function when the second arm forms a −45°˜−90° angle with the first arm; the damping force can vary according to different angles formed by the second arm and the first arm, reducing the gravity and motion inertia of the second arm and the driving power of the second arm working module. Meanwhile, the power consumption during the operation can be decreased accordingly.

In some embodiments, the main shaft is supported by two wallboards disposed perpendicularly on the base; and, the two wallboards are disposed in parallel. The gravity balance block is disposed in the middle of the two wallboards.

Additionally, the axis lines of the first arm working pushrod, the second arm working pushrod and the main shaft are on the same plane.

In some embodiments, a parallelogram supporting base is fixed to one side of the base near the protruding portion of the main shaft. The first connecting shaft is supported by the upper end face of the parallelogram supporting base. The bottoms of two parallel-arranged first control rods are respectively hinged to the first connecting shaft. A joint shaft is inserted into where the second arm is hinged to the first arm; the joint shaft is provided with a protruding center convex rod; the front end of the center convex rod is provided with a connecting base; the connecting base, the center convex rod and the joint shaft form an integral structure; the upper ends of two parallel-arranged first control rods are respectively hinged to the connecting base; the lower ends of two parallel-arranged second control rods are respectively hinged to the connecting base.

In another embodiment of the present invention, two parallel-arranged connecting shafts are respectively disposed on the connecting base, comprising the second connecting shaft located at the lower part and the third connecting shaft located at the upper part. The upper ends of the two parallel-arranged first control rods are respectively hinged to the second connecting shaft; and, the lower ends of the two parallel-arranged second control rods are respectively hinged to the third connecting shaft.

Compared with the prior art, the present invention provides the following advantages:

The robot using the parallelogram principle, of which the heads and the ends of two groups of swing arm components, are hinged together and each group forms two parallelogram hinged structures. Consequently, the workpiece gripped by the gripper can be kept in a horizontal position during the operational process of the robot, improving the stability of gripping a workpiece. In contrast to the traditional robot requiring an auxiliary driving unit for keeping the horizontal movement of a workpiece, the present invention has low power consumption, a simple structure, and low manufacturing cost.

### BRIEF DESCRIPTION OF THE DRAWINGS

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

FIG. 1 is a front view structure diagram of embodiment 1 of the present invention.

FIG. 2 is a side view of FIG. 1.

FIG. 3 is a front view of the swing arm components in embodiment 1 of the present invention.

FIG. 4 is a side view of FIG. 3.

FIG. 5 is a front view state diagram of placing a workpiece into the equipment in embodiment 1 of the present invention.

FIG. 6 is a side view state diagram of FIG. 5.

FIG. 7 is a front view structure diagram of embodiment 2 of the present invention.

FIG. 8 is a three-dimensional diagram of embodiment 2 of the present invention (the base 1 is section-viewed).

### MARKING INSTRUCTION OF THE DRAWINGS

Base 1. Gravity Balance Block 2. Main Shaft 3. The First Arm Working Module 4. Main Shaft Servo Motor 5. Main Shaft Speed Reducer 6. The First Sliding Block 7. The First Arm Working Module Servo Motor 8. Coupling 9. The First Arm Working Pushrod 10. Gripper Connector 11. Gripper 12. Universal Coupling 13. Parallel Fixed Plate 14. The Third Arm 15. The Third Arm Rotating Sleeve 16. Rotating Sleeve Connector 17. The Second Control Rod 18. The Second Arm 19. Horizontal Transverse Support 20. The First Control Rod 21. The First Arm 22. The Second Arm Working Pushrod 23. The Second Sliding Block 24. The Second Arm Working Module 25. The Second Arm Working Module Servo Motor 26. Wallboard 27. Supporting Components 28. Vertical-direction Support 29. Horizontal Transverse Track 30. Vertical-direction Track 31. Vertical-direction Sliding Block 32. Connecting Rod 33. End Gripper 34. Flexible Shaft Servo Motor 35. Motor Output Flexible Shaft 36. Driving Synchronous Wheel 37. Driven Synchronous Wheel 38. Synchronous Belt 39. Transverse Installation Channel 40. Transverse-direction balance block 41. Internal Chamber 42. Balance Block Connecting Plate 43. Vertical-direction Cylinder 44. Damping Brake Mechanism 45. Damping Spring Group 46. Damping Spring Plate 47. Parallelogram Supporting Base 48. The First Connecting Shaft 49, Joint Shaft 50. Center Convex Rod 51. Connecting Base 52. The Second Connecting Shaft 53. The Third Connecting Shaft 54. Dust Cover 55

### DETAILED DESCRIPTION OF THE INVENTION

Drawings and detailed embodiments are combined hereinafter to elaborate the technical principles of the present invention. The arrow direction in the drawings is the rotating direction of the corresponding component.

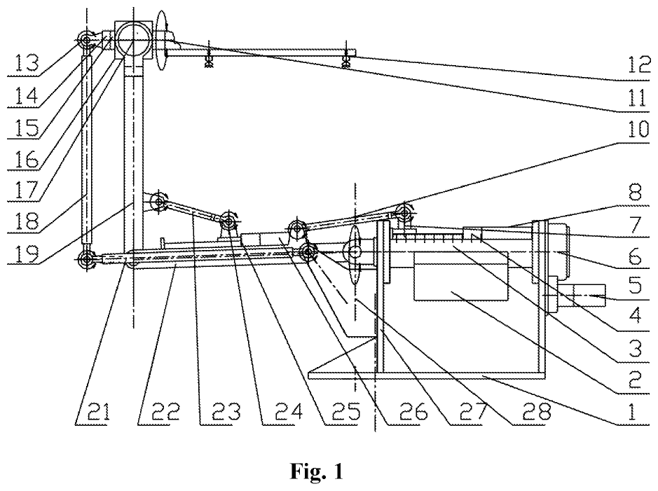

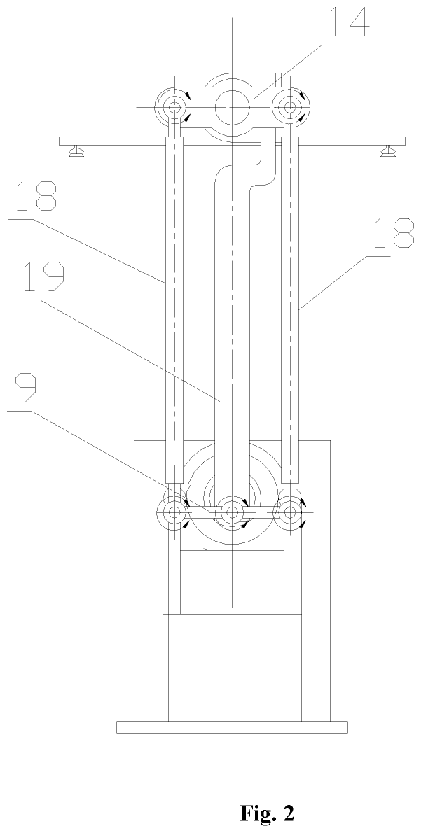

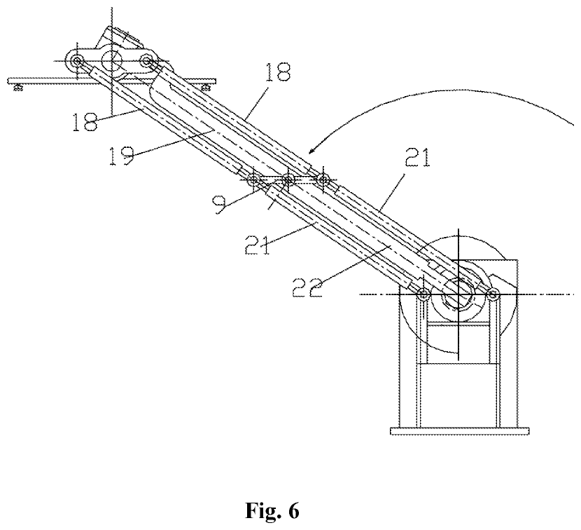

As shown in FIGS. 1-8, a robot using the parallelogram principle comprises a base 1 comprising a main shaft 3, which can rotate horizontally; one end of the main shaft 3 comprises a main shaft servo motor 5 for propelling the main shaft 3 to rotate, and the other end of the main shaft 3 is connected to the swing arm components. Through propelling the main shaft 3, the main shaft servo motor 5 further propels the swing arm components to swing in circumferential direction around the main shaft 3. The free end of the swing arm components is connected to a gripper for gripping a workpiece. The swing arm components comprise the first swing arm components and the second swing arm components, which are hinged together. The first swing arm components comprise the first arm 22, which is hinged to the end of the main shaft 3; one side of the first arm 22 is provided with two first control rods 21 for supporting the swing of the first arm 22. The two first control rods 21 and the first arm 22 form a hinged parallelogram structure. The two first control rods 21 also form a hinged parallelogram structure; the second swing arm components comprise the second arm 19 and two second control rods 18; one end of the second arm 19 is hinged to one end of the first arm 22, which is far from the main shaft 3; the other end of the second arm 19 is hinged to the gripper 12. The two second control rods 18 are respectively hinged to the ends of the two first control rods 21; the two second control rods 18 form a hinged parallelogram structure; the two second control rods 18 and the second arm 19 also form a hinged parallelogram structure. The first arm working module 4, which is used for propelling the first arm 22 to rotate nearer or farther from the processing position of a workpiece, is disposed between the first arm 22 and the main shaft 3; the second arm working module 25, which is used for propelling the second arm 19 to rotate nearer or farther from the processing position of a workpiece, is disposed between the second arm 19 and the first arm 22. One end of the second arm 19, which is far from the first arm 22, is hinged to the third arm rotating sleeve 16; the third arm rotating sleeve 16 is provided with the rotatable third arm 15; one end of the third arm 15, which extends towards one side of the second control rod 18 in a horizontal direction, is connected to a parallel fixed plate 14; the parallel fixed plate 14 is hinged to the end of the second control rod 18; one end of the third arm 15, which is far from the second control rod 18, extends through the third arm rotating sleeve 16 and is fixedly connected to the gripper 12.

### Embodiment 1

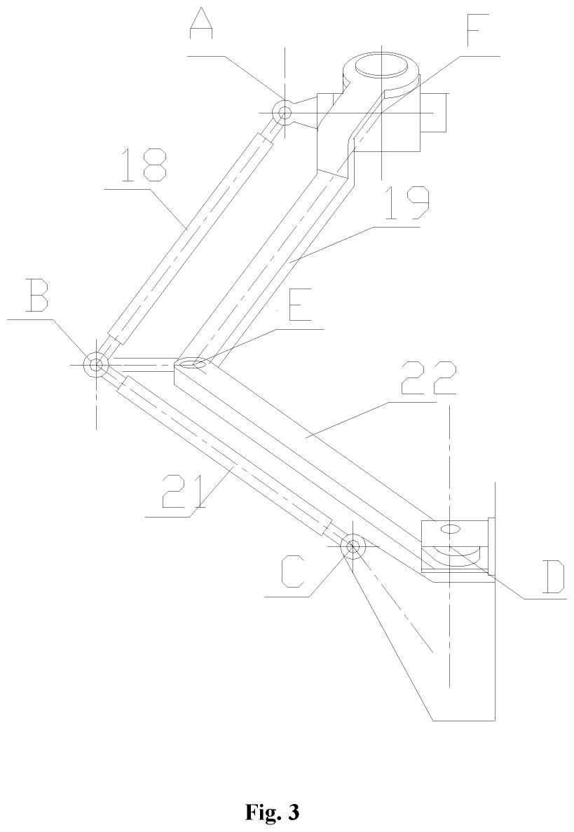

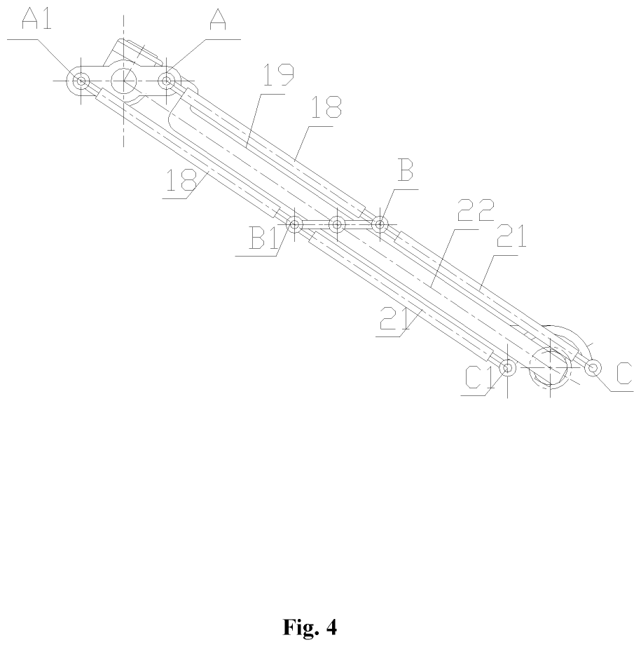

As shown in FIGS. 1-6, a robot using the parallelogram principle comprises a base 1 comprising a main shaft 3, which can rotate horizontally; one end of the main shaft 3 comprises a main shaft servo motor 5 for propelling the main shaft 3 to rotate, and the other end of the main shaft 3 is connected to the swing arm components. Through propelling the main shaft 3, the main shaft servo motor 5 further propels the swing arm components to swing in circumferential direction around the main shaft 3. The free end of the swing arm components is connected to a gripper for gripping a workpiece; the swing arm components comprise the first swing arm components and the second swing arm components, which are hinged together. The first swing arm components comprise the first arm 22, which is hinged to the end of the main shaft 3; one side of the first arm 22 is provided with two first control rods 21 for supporting the swing of the first arm 22; the two first control rods 21 are hinged to the base 1 through the supporting components 28. Referring to the four hinge points B, C, D, and E in FIG. 3, the two first control rods 21 and the first arm 22 form a hinged parallelogram structure. Referring to the four hinge points B1, C1, C, and B in FIG. 4, the two first control rods 21 also form a hinged parallelogram structure. The second swing arm components comprise the second arm 19 and two second control rods 18. One end of the second arm 19 is hinged to one end of the first arm 22, which is far from the main shaft 3. The other end of the second arm 19 is hinged to the gripper 12. The two second control rods 18 are respectively hinged to the ends of the two first control rods 21. Referring to the four hinge points A1, B1, B, and A in FIG. 4, the two second control rods 18 form a hinged parallelogram structure; referring to the four hinge points A, B, E, and F in FIG. 3, the two second control rods 18 and the second arm 19 also form a hinged parallelogram structure; the first arm working module 4, which is used for propelling the first arm 22 to rotate nearer or farther from the processing position of a workpiece, is disposed between the first arm 22 and the main shaft 3. The second arm working module 25, which is used for propelling the second arm 19 to rotate nearer or farther from the processing position of a workpiece, is disposed between the second arm 19 and the first arm 22. In this embodiment, the heads and the ends of two groups of swing arm components of the dual-shaft, dual-directional parallel-pathed robot are hinged together, and each group forms two parallelogram hinged structures. Consequently, the workpiece gripped by the gripper can be kept in a horizontal position during the operational process of the robot, improving the stability of gripping a workpiece. In contrast to a traditional robot requiring an auxiliary driving unit for keeping the horizontal movement of a workpiece, the present robotic device has low power consumption, a simple structure, and low manufacturing cost.

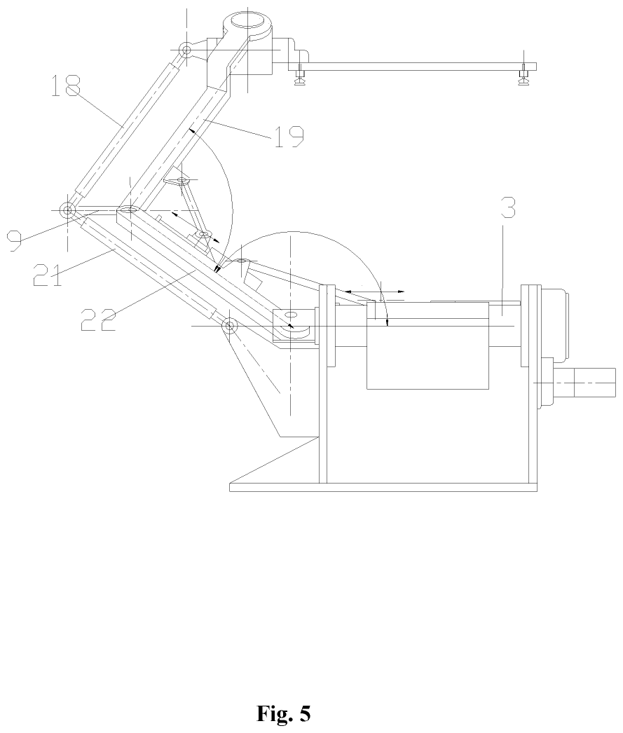

The first arm working module 4 comprises the first arm working pushrod 10. One end of the first arm working pushrod 10 is hinged to the first arm 22 and the other end is hinged to the first sliding block 7; the first sliding block 7 is disposed in the guide track of the first arm working module 4; the first sliding block 7 is propelled by the first arm working module servo motor 8 to reciprocate linearly along the axis direction of the main shaft 3, namely, moving to the left side or right side of FIG. 5.

The second arm working module 25 comprises the second arm working pushrod 23. One end of the second arm working pushrod 23 is hinged to the second arm 19 and the other end is hinged to the second sliding block 24. The second sliding block 24 is disposed in the guide track of the second arm working module 25; the second sliding block 24 is propelled by the second arm working module servo motor 26 to reciprocate linearly along the axis direction of the second arm 19, namely, moving to the left side or right side of FIG. 5.

The gravity balance block 2 is disposed underneath the main shaft 3; when the main shaft 3 does not rotate, the gravity center of the gravity balance block 2 and the plane of the axis line of the main shaft 3 are perpendicular to the horizontal plane. The weight of the gravity balance block 2 corresponds to the total weight of the swing arm components, the gripper and the workpiece, which is in the range of 18 kg-27 kg. Referring to FIG. 4, when the swing arm components swing in the left and right, the gravity balance block 2 rotates along the main shaft 3, and the gravity center of the gravity balance block 2 rises. Under the action of the gravity balance block 2, a twisting force, which is reverse to the rotating direction of the main shaft 3, is imposed to the main shaft 3. Consequently, the driving torque can be reduced to 60% of the second shaft torque so as to reduce the manufacturing cost and save energy.

The main shaft 3 is supported by two wallboards 27 disposed perpendicularly on the base 1. The two wallboards 27 are disposed in parallel, and the gravity balance block 2 is disposed in the middle of the two wallboards 27.

The axis lines of the first arm working pushrod 10, the second arm working pushrod 23 and the main shaft 3 are on the same plane, ensuring stability and accuracy when placing a workpiece on the worktable or taking a workpiece from the worktable.

One end of the second arm 19, which is far from the first arm 22, is hinged to the third arm rotating sleeve 16 through the rotating sleeve connector 17. The third arm rotating sleeve 16 is provided with the rotatable third arm 15. One end of the third arm 15, which extends towards one side of the second control rod 18 in a horizontal direction, is connected to a parallel fixed plate 14. The parallel fixed plate 14 is hinged to the end of the second control rod 18 through the universal coupling 13. One end of the third arm 15, which is far from the second control rod 18, extends through the third arm rotating sleeve 16 and connects to the gripper 12 fixedly. The gripper 12 is connected to the second control rod 18 through the gripper connector 11.

The hinge point at the bottom of the first control rod 21 is at the same horizontal level as the hinge point at the bottom of the first arm 22, providing a convenient installation and ensuring stability during the operation of the gripper.

A T-shaped structure is formed between the first arm 22 and the two first control rods 21. The two first control rods 21 are symmetrically disposed at the two sides of the first arm 22; a T-shaped structure is also formed between the second arm 19 and the two second control rods 18; the two second control rods 18 are symmetrically disposed at the two sides of the second arm 19; the first swing arm component is hinged to the second swing arm component through the coupling 9.

For conveniently controlling the rotating speed of the main shaft 3, the driving torque of the main shaft 3 is increased and the main shaft speed reducer 6 is disposed between the main shaft servo motor 5 and the main shaft 3. The main shaft servo motor 5 and the main shaft speed reducer 6 are both fixed on one wallboard 27.

### Embodiment 2

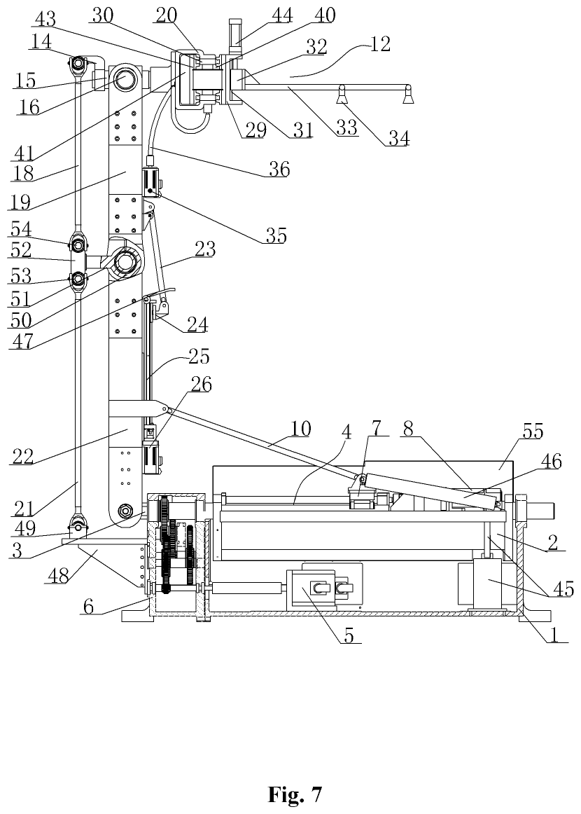

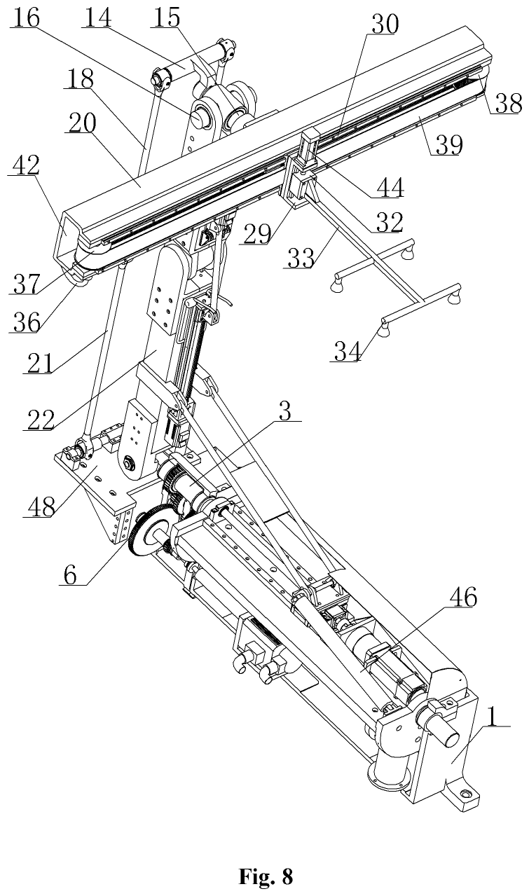

FIGS. 7 and 8 show the seven-axial robot using the parallelogram principle, wherein the head and the ends of two groups of swing arm components are hinged together, and each group forms two hinged parallelogram structures. The gripper 12 comprises a transverse-direction driving unit, a vertical-direction driving unit and an end gripper 34. The transverse-direction driving unit comprises a horizontal transverse support 20 and a horizontal transverse power unit. The vertical-direction driving unit comprises a vertical-direction power unit and a vertical-direction support 29; the third arm 15 extends through the third arm rotating sleeve 16 and is fixedly connected to the horizontal transverse support 20; the interior of the horizontal transverse support 20 is provided with a horizontal transverse track 30. The vertical-direction support 29 is movably coupled in the horizontal transverse track 30; the output end of the horizontal transverse power unit is connected to the vertical-direction support 29; the vertical-direction support 29 reciprocates along the horizontal transverse track 30; the vertical-direction track 31 is disposed inside the vertical-direction support 29; a vertical-direction sliding block 32 is embedded in the vertical-direction track 31; the vertical-direction sliding block 32 is connected to the end gripper 34 through the connecting rod 33; the output end of the vertical-direction power unit is connected to the vertical-direction sliding block 32.

The length of the horizontal transverse track 30 is 1500 mm.

The horizontal transverse power unit comprises a flexible shaft servo motor 35, a motor output flexible shaft 36, a driving synchronous wheel 37, a driven synchronous wheel 38 and a synchronous belt 39; the flexible shaft servo motor 35 is connected to the driving synchronous wheel 37 through the motor output flexible shaft 36; the driving synchronous wheel 37 is connected to the driven synchronous wheel 38 through the synchronous belt 39. The synchronous belt 39 is disposed in the transverse-direction installation channel 40 of the horizontal transverse support 20. The driving synchronous wheel 37 and the driven synchronous wheel 38 are respectively disposed at the two ends of the transverse-direction installation channel 40. The end face of the outer side of the synchronous belt 39 is fixedly connected to the vertical-direction support 29; meanwhile, the vertical-direction support 29 is installed in the protruding horizontal transverse track 30 in a stuck manner; the flexible shaft servo motor 35 propels the driving synchronous wheel 37 to rotate so that the synchronous belt 39 is propelled to drive the vertical-direction support 29 to horizontally move along the horizontal transverse track 30. Consequently, the end gripper 34 can move horizontally, providing the robot a wider working range.

The transverse-direction balance block 41 is disposed inside of the horizontal transverse track 20, ensuring the stability of the whole structure during the operation.

The transverse-direction balance block 41 is embedded in the internal chamber 42 of the horizontal transverse support 20 and fixed to the horizontal transverse track 30 through the balance block connecting plate 43 so that the horizontal transverse track 30 can be reasonably arranged and the structure can be more stable.

The flexible shaft servo motor 35 is fixed to the second arm 19. The length of the motor output flexible shaft 36 can ensure the normal operation of the robot and avoid tangles.

The vertical-direction power unit is a vertical-direction cylinder 44; the vertical-direction cylinder 44 is fixed to the vertical-direction support 29; the lower end of the piston rod of the vertical-direction cylinder 44 is connected to the vertical-direction sliding block 32; the vertical-direction sliding block 32 is propelled by the vertical-direction cylinder 44 to move upwards and downwards along the vertical-direction track 31, enabling the end gripper 34 to be adjusted precisely in the vertical direction. The end gripper 34 can move 0-100 mm upwards and downwards, allowing each of the servo motors to stop working when gripping or placing a workpiece, which is helpful for reducing the power consumption during the normal operation of a robot, and prolonging the life-span of each servo motor.

A gravity balance block 2 is disposed under the main shaft 3, where is far from the first arm 22; when the main shaft 3 is not rotating, the gravity center of the gravity balance block 2 and the plane of the axis line of the main shaft 3 are perpendicular to the horizontal plane, reducing the driving power accordingly and resulting in decreased power consumption.

The end of the main shaft 3, which is far from the first arm 22, is provided with a damping brake mechanism 45, which can generate different damping force according to the size of the rotational angle so as to reduce the motion inertia of the main shaft.

The first arm working module 4 comprises the first arm working pushrod 10; one end of the first arm working pushrod 10 is hinged to the first arm 22 and the other end is hinged to the first sliding block 7; the first sliding block 7 is disposed in the guide track of the first arm working module 4; the first sliding block 7 is propelled by the first arm working module servo motor 8 to reciprocate linearly along the axis direction of the main shaft 3.

The first sliding block 7 is connected to the end of the first arm working module 4 through the damping spring group, reducing the gravity and motion inertia when the first arm moves to −45°˜−80. Consequently, the driving power of the first arm working module 4 and the power consumption during the operation can be reduced accordingly.

The second arm working module 25 comprises the second arm working pushrod 23; one end of the second arm working pushrod 23 is hinged to the second arm 19 and the other end is hinged to the second sliding block 24; the second sliding block 24 is disposed in the guide track of the second arm working module 25; the second sliding block 24 is propelled by the second arm working module servo motor 26 to reciprocate linearly along the axis direction of the second arm 19.

The upper part of the inner side of the first arm 22 is provided with a damping spring plate 47; the damping spring plate 47 starts to function when the second arm 19 forms a −45°˜−90° angle with the first arm 22; the damping force can vary according to different angles formed by the second arm 19 and the first arm 22, reducing the gravity and motion inertia of the second arm 19 and the driving power of the second arm working module 25. Meanwhile, the power consumption during the operation can be decreased accordingly.

The axis lines of the first arm working pushrod 10, the second arm working pushrod 23 and the main shaft 3 are on the same plane.

A parallelogram supporting base 48 is fixed to one side of the base 1 near the protruding portion of the main shaft 3; the first connecting shaft 49 is supported by the upper end face of the parallelogram supporting base 48; the bottoms of two parallel-arranged first control rods 21 are respectively hinged to the first connecting shaft 49; a joint shaft 50 is inserted into where the second arm 19 is hinged to the first arm 22; the joint shaft 50 is provided with a protruding center convex rod 51; the front end of the center convex rod 51 is provided with a connecting base 52; the connecting base 52, the center convex rod 51 and the joint shaft 50 form an integral structure; the upper ends of two parallel-arranged first control rods 21 are respectively hinged to the connecting base 52; and, the lower ends of two parallel-arranged second control rods 18 are respectively hinged to the connecting base 52.

The third arm 15, the center convex rod 51 and the main shaft 3 are arranged in parallel, ensuring that the heads and the ends of the two groups of swing arm components are hinged together and each group forms two hinged parallelogram structures.

Two parallel-arranged connecting shafts are respectively disposed on the connecting base 52, including the second connecting shaft 53 located at the lower part, and the third connecting shaft 54 located at the upper part. The upper ends of the two parallel-arranged first control rods 21 are respectively hinged to the second connecting shaft 53; the lower ends of the two parallel-arranged second control rods 18 are respectively hinged to the third connecting shaft 54.

Specifically, the main shaft speed reducer in embodiment 2 is a gear box.

The end gripper 34 in embodiment 2 can be propelled by the flexible shaft servo motor 35 to move left and right about 1500 mm in transverse direction, and propelled by the vertical-direction cylinder 44 to move upwards and downwards about 100 mm in a vertical direction, providing a wider working range for the robot's end gripper 34, which is more suitable for automatic production.

Specifically, the base in embodiment 1 and 2 can be provided with a dust cover 55 for dust shielding.

The previous descriptions are of preferred examples for implementing the invention, and the scope of the invention should not necessarily be limited by this description. Rather, the scope of the present invention is defined by the claims.

1. A robot using the parallelogram principle, comprising:
a base, comprising a main shaft that can rotate horizontally, wherein one end of the main shaft comprises a main shaft servo motor for propelling the main shaft to rotate, and the other end of the main shaft is connected to the swing arm components,
wherein through propelling the main shaft, the main shaft servo motor further propels the swing arm components to swing in circumferential direction around the main shaft,
wherein the free end of the swing arm components is connected to a gripper for gripping a workpiece, wherein the swing arm components comprise the first swing arm components and the second swing arm components, which are hinged together, wherein the first swing arm components comprise the first arm, which is hinged to the end of the main shaft,
wherein one side of the first arm is provided with two first control rods for supporting the swing of the first arm, wherein the two first control rods and the first arm form a hinged parallelogram structure, wherein the two first control rods also form a hinged parallelogram structure, wherein the second swing arm components comprise the second arm and two second control rods, wherein one end of the second arm is hinged to one end of the first arm, which is far from the main shaft, wherein the other end of the second arm is hinged to the gripper, wherein the two second control rods are respectively hinged to the ends of the two first control rods, wherein the two second control rods form a hinged parallelogram structure, wherein the two second control rods and the second arm also form a hinged parallelogram structure too, wherein the first arm working module, which is used for propelling the first arm to rotate nearer or farther from the processing position of a workpiece, is disposed between the first arm and the main shaft, wherein the second arm working module, which is used for propelling the second arm to rotate nearer or farther from the processing position of a workpiece, is disposed between the second arm and the first arm, wherein one end of the second arm, which is far from the first arm, is hinged to the third arm rotating sleeve, wherein the third arm rotating sleeve is provided with the rotatable third arm, wherein one end of the third arm, which extends towards one side of the second control rod in horizontal direction, is connected to a parallel fixed plate, wherein the parallel fixed plate is hinged to the end of the second control rod, wherein one end of the third arm, which is far from the second control rod, extends through the third arm rotating sleeve and is fixedly connected to the gripper.

2. A robot using the parallelogram principle of claim 1, wherein the gripper comprises:
a transverse-direction driving unit;
a vertical-direction driving unit, and
an end gripper, wherein the transverse-direction driving unit comprises a horizontal transverse support and a horizontal transverse power unit, wherein the vertical-direction driving unit comprises a vertical-direction power unit and a vertical-direction support, wherein the third arm extends through the third arm rotating sleeve and is fixedly connected to the horizontal transverse support, wherein the interior of the horizontal transverse support is provided with a horizontal transverse track, wherein the vertical-direction support is installed in the horizontal transverse track in a stuck manner, wherein the output end of the horizontal transverse power unit is connected to the vertical-direction support, wherein
the vertical-direction support reciprocates along the horizontal transverse track, wherein the vertical-direction track is disposed inside the vertical-direction support, wherein a vertical-direction sliding block is embedded in the vertical-direction track, wherein the vertical-direction sliding block is connected to the end gripper through the connecting rod, wherein the output end of the vertical-direction power unit is connected to the vertical-direction sliding block.

3. A robot using the parallelogram principle of claim 2, wherein the horizontal transverse power unit comprises a flexible shaft servo motor, a motor output flexible shaft, a driving synchronous wheel, a driven synchronous wheel and a synchronous belt, wherein the flexible shaft servo motor is connected to the driving synchronous wheel through the motor output flexible shaft, wherein the driving synchronous wheel is connected to the driven synchronous wheel through the synchronous belt, wherein the synchronous belt is disposed in the transverse-direction installation channel of the horizontal transverse support, wherein the driving synchronous wheel and the driven synchronous wheel are respectively disposed at the two ends of the transverse-direction installation channel, wherein the end face of the outer side of the synchronous belt is fixedly connected to the vertical-direction support, wherein the vertical-direction support is movably coupled in the protruding horizontal transverse track, wherein the flexible shaft servo motor propels the driving synchronous wheel to rotate so that the synchronous belt is propelled to drive the vertical-direction support to horizontally move along the horizontal transverse track.

4. A robot using the parallelogram principle of claim 3, wherein a transverse-direction balance block is embedded in the internal chamber of the horizontal transverse support and fixed to the horizontal transverse track through the balance block connecting plate.

5. A robot using the parallelogram principle of claim 3, wherein the flexible shaft servo motor is fixed to the second arm, wherein the length of the motor output flexible shaft can ensure the normal operation of the robot and avoid tangles.

6. A robot using the parallelogram principle of claim 2, wherein the vertical-direction power unit is a vertical-direction cylinder, wherein the vertical-direction cylinder is fixed to the vertical-direction support, wherein the lower end of the piston rod of the vertical-direction cylinder is connected to the vertical-direction sliding block, wherein the vertical-direction sliding block is propelled by the vertical-direction cylinder to move upwards and downwards along the vertical-direction track.

7. A robot using the parallelogram principle of claim 1, wherein a gravity balance block is disposed under the main shaft, which is far from the first arm, wherein when the main shaft is not rotating, the gravity center of the gravity balance block and the plane of the main shaft axis line are perpendicular to the horizontal plane.

8. A robot using the parallelogram principle of claim 1, wherein the end of the main shaft, which is far from the first arm, comprises a damping brake mechanism, which can obtain different damping force according to the size of the rotational angle.

9. A robot using the parallelogram principle of claim 1, wherein the first arm working module comprises the first arm working pushrod, wherein one end of the first arm working pushrod is hinged to the first arm and the other end is hinged to the first sliding block, wherein the first sliding block is disposed in the guide track of the first arm working module, wherein the first sliding block is propelled by the first arm working module servo motor to reciprocate linearly along the axis direction of the main shaft.

10. A robot using the parallelogram principle of claim 9, wherein the first sliding block is connected to the end of the first arm working module through the damping spring group.

11. A robot using the parallelogram principle of claim 1, wherein the second arm working module comprises the second arm working pushrod, wherein one end of the second arm working pushrod is hinged to the second arm and the other end is hinged to the second sliding block, wherein the second sliding block is disposed in the guide track of the second arm working module, wherein the second sliding block is propelled by the second arm working module servo motor to reciprocate linearly along the axis direction of the second arm.

12. A robot using the parallelogram principle of claim 11, wherein the upper part of the inner side of the first arm comprises with a damping spring plate.

13. A robot using the parallelogram principle of claim 1, wherein the axis lines of the first arm working pushrod, the second arm working pushrod and the main shaft are on the same plane.

14. A robot using the parallelogram principle of claim 1, wherein a parallelogram supporting base is fixed to one side of the base near the protruding portion of the main shaft, wherein the first connecting shaft is supported by the upper end face of the parallelogram supporting base, wherein the bottoms of two parallel-arranged first control rods are respectively hinged to the first connecting shaft, wherein a joint shaft is inserted into where the second arm is hinged to the first arm, wherein the joint shaft comprises a protruding center convex rod, wherein the front end of the center convex rod comprises a connecting base, wherein the connecting base, the center convex rod and the joint shaft form an integral structure, wherein the upper ends of two parallel-arranged first control rods are respectively hinged to the connecting base, wherein the lower ends of two parallel-arranged second control rods are respectively hinged to the connecting base.

15. A robot using the parallelogram principle of claim 14, wherein two parallel-arranged connecting shafts are respectively disposed on the connecting base, comprising a second connecting shaft located at the lower part and the third connecting shaft located at the upper part, wherein the upper ends of the two parallel-arranged first control rods are respectively hinged to the second connecting shaft, wherein the lower ends of the two parallel-arranged second control rods are respectively hinged to the third connecting shaft.

16. A robot using the parallelogram principle of claim 2, wherein a gravity balance block is disposed under the main shaft, which is far from the first arm, wherein when the main shaft is not rotating, the gravity center of the gravity balance block and the plane of the main shaft axis line are perpendicular to the horizontal plane.

17. A robot using the parallelogram principle of claim 2, wherein the end of the main shaft, which is far from the first arm, comprises a damping brake mechanism, which can obtain different damping force according to the size of the rotational angle.

18. A robot using the parallelogram principle of claim 2, wherein the first arm working module comprises the first arm working pushrod, wherein one end of the first arm working pushrod is hinged to the first arm and the other end is hinged to the first sliding block, wherein the first sliding block is disposed in the guide track of the first arm working module, wherein the first sliding block is propelled by the first arm working module servo motor to reciprocate linearly along the axis direction of the main shaft.

19. A robot using the parallelogram principle of claim 18, wherein the first sliding block is connected to the end of the first arm working module through the damping spring group.

20. A robot using the parallelogram principle of claim 2, wherein the second arm working module comprises the second arm working pushrod, wherein one end of the second arm working pushrod is hinged to the second arm and the other end is hinged to the second sliding block, wherein the second sliding block is disposed in the guide track of the second arm working module, wherein the second sliding block is propelled by the second arm working module servo motor to reciprocate linearly along the axis direction of the second arm.

21. A robot using the parallelogram principle of claim 20, wherein the upper part of the inner side of the first arm comprises with a damping spring plate.

22. A robot using the parallelogram principle of claim 2, wherein the axis lines of the first arm working pushrod, the second arm working pushrod and the main shaft are on the same plane.

23. A robot using the parallelogram principle of claim 2, wherein a parallelogram supporting base is fixed to one side of the base near the protruding portion of the main shaft, wherein the first connecting shaft is supported by the upper end face of the parallelogram supporting base, wherein the bottoms of two parallel-arranged first control rods are respectively hinged to the first connecting shaft, wherein a joint shaft is inserted into where the second arm is hinged to the first arm, wherein the joint shaft comprises a protruding center convex rod, wherein the front end of the center convex rod comprises a connecting base, wherein the connecting base, the center convex rod and the joint shaft form an integral structure, wherein the upper ends of two parallel-arranged first control rods are respectively hinged to the connecting base, wherein the lower ends of two parallel-arranged second control rods are respectively hinged to the connecting base.

24. A robot using the parallelogram principle of claim 23, wherein two parallel-arranged connecting shafts are respectively disposed on the connecting base, comprising a second connecting shaft located at the lower part and the third connecting shaft located at the upper part, wherein the upper ends of the two parallel-arranged first control rods are respectively hinged to the second connecting shaft, wherein the lower ends of the two parallel-arranged second control rods are respectively hinged to the third connecting shaft.
